(19) United States
(12) Patent Application Publication
(10) Pub. No.: US 2004/0190977 A1
(43) Pub. Date: Sep. 30, 2004

(54) Coaxial cable conduit extender

(75) Inventor: Gerard J. Matern, Waterloo (CA)

Correspondence Address: SHOOK, HARDY & BACON LLP, 2555 GRAND BLVD, KANSAS CITY,, MO, 64108, US

(73) Assignee: Leggett & Platt Ltd.

(21) Appl. No.: 10/400,606

(22) Filed: Mar. 27, 2003

(51) Int. Cl. F16B 7/10; F16D 1/12

(52) U.S. Cl. 403/105; 403/109.1

(57) ABSTRACT

A coaxial cable extender having only two parts overcomes the complexity of prior devices while maintaining functionality. The extender includes a sleeve, attached to a conduit of the coaxial cable, having a ratchet toothed rack and a slider received on the sleeve. The slider has an integral arm with ratchet teeth biased against the ratchet toothed rack such that the slider may be ratcheted along the ratchet toothed rack to extend the effective length of the conduit.

### FIELD OF THE INVENTION

The present invention relates to coaxial cable and, more particularly, to an extender for adjusting the effective length of the conduit of a coaxial cable.

### BACKGROUND

The use of coaxial cable for transferring motion from one location to another, remote, location is well known in the technology associated with bicycle braking and gearing systems as well as automobile throttle systems. The use of coaxial cable may be less well known, but just as functional, in other applications, such as the adjustment of various aspects of office chairs.

The coaxial cable typically comprises only two parts, a cable and a conduit for the cable, although there may be assemblies of many more parts on the controlling and controlled ends of the coaxial cable.

It has been recognized that the effective length of the conduit is important to the proper operation of the coaxial cable as a whole. With this in mind, several devices have been devised to adjust the effective length of the conduit. Example effective length adjusters include U.S. Pat. No. 4,694,706, issued Sep. 22, 1987 to Lichtenberg et al., U.S. Pat. No. 4,688,445, issued Aug. 25, 1987 to Spease et al. and U.S. Pat. No. 5,142,933, issued Sep. 1, 1992 to Kelley.

In U.S. Pat. No. 4,694,706, a ratchet toothed rack is attached to the cable. A pawl with ratchet teeth engages the ratchet toothed rack to prevent longitudinal movement of the cable. The pawl may be rotated to a position wherein the ratchet teeth of the pawl no longer engage the ratchet toothed rack and the cable may be allowed to retract within the conduit. Although useful, the disclosed device requires the end of the cable to be fitted with the ratchet toothed rack. It may be that the end of the cable is to be used for a predetermined purpose that precludes use of this arrangement for adjusting the effective length of the conduit.

In U.S. Pat. No. 4,688,445, a support member is attached to the conduit of the coaxial cable. The support member has a ratchet toothed rack. A slider member is received on the support member. The slider member has a ratchet toothed member biased against the ratchet toothed rack of the support member. A button is provided, the pressing of which temporarily overcomes the bias and disengages the ratchet toothed member of the slider member from the ratchet toothed rack of the support member. The disengagement allows the slider to be moved longitudinally along the support member.

Similarly, in U.S. Pat. No. 5,142,933, a support member is attached to the conduit of the coaxial cable. The support member has a toothed rack. A slider member is received on the support member. The slider member has a toothed member biased against the toothed rack of the support member. Movement of a lever into a particular position disengages the toothed member of the slider member from the toothed rack of the support member, thus allowing the slider member to be moved longitudinally along the support member.

In both of the latter two patents discussed hereinbefore, the slider member is a complex arrangement of parts including a biasing member, a locking member and a means to move the locking member from an engaged position to a disengaged position.

Clearly, a coaxial cable conduit extender is required whose design is simple, whose number of components is minimized and that does not have a requirement that the end of the cable be altered.

### SUMMARY

A coaxial cable extender having only two parts overcomes the complexity of prior devices while maintaining functionality. In particular, the parts include a sleeve, attached to the coaxial conduit to be extended, and a conduit extending slider received on the sleeve. The slider is normally prevented from sliding along the sleeve, in the direction that would reduce the effective length of the conduit, by a ratchet mechanism. On the other hand, the ratchet mechanism allows the slider to slide along the sleeve in the direction that would extend the effective length of the conduit.

In accordance with an aspect of the present invention there is provided an extender for a conduit of a coaxial cable. The extender includes a first member adapted to be attached to the conduit, the first member having a ratchet toothed rack, and a slider having an integral arm, the integral arm having ratchet teeth adapted to be biased against the ratchet toothed rack such that the slider may be ratcheted along the ratchet toothed rack to extend an effective length of the conduit.

In accordance with another aspect of the present invention there is provided an extender for a conduit of a coaxial cable. The extender includes a first member attached to the conduit, the first member having a ratchet toothed rack, and a slider having an integral arm, the integral arm having ratchet teeth biased against the ratchet toothed rack such that the slider may be ratcheted along the ratchet toothed rack to extend an effective length of the conduit.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate example embodiments of this invention:

FIG. 1 is a side view of the coaxial cable and a conduit extender according to an embodiment of the present invention;

FIG. 2 is a top view of the conduit extender of FIG. 1;

FIG. 3 is a sectional view taken substantially along line 3-3 of FIG. 2;

FIG. 3A is an exploded view of FIG. 3;

FIG. 4 is a sectional view taken substantially along line 4-4 of FIG. 2; and

FIG. 5 is a sectional view taken substantially along line 5-5 of FIG. 2.

### DETAILED DESCRIPTION

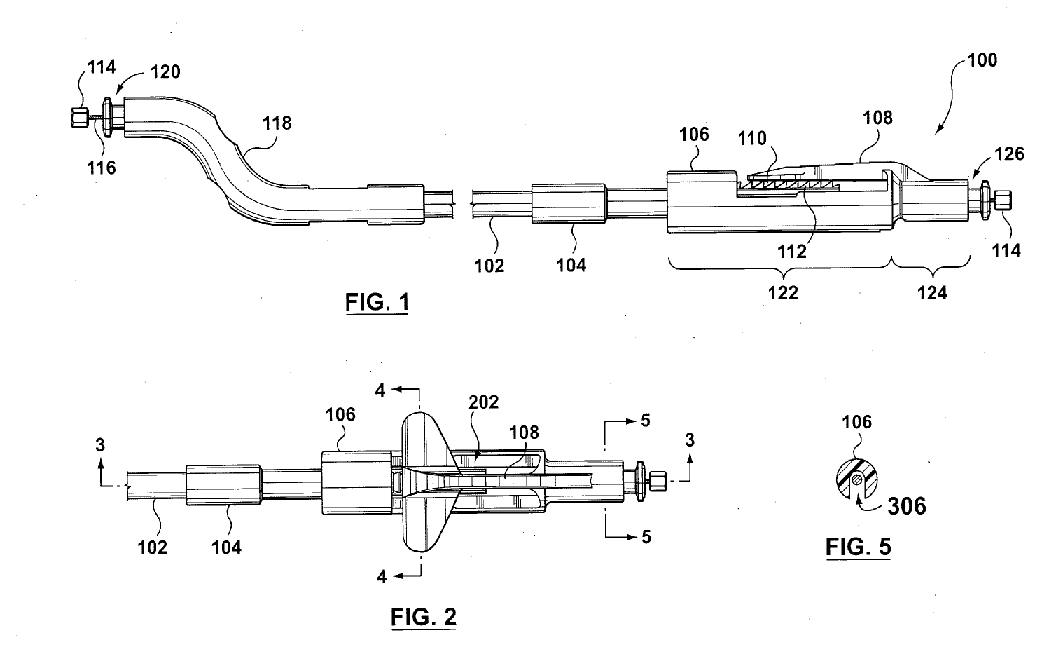

FIG. 1 illustrates a coaxial cable including a cable 116 and a conduit 102 through which the cable 116 may be longitudinally moved. The cable 116 is shown to extend through an end member 118, which attaches to the conduit 102 at one end. The end member 118 includes a circumferential groove 120 for facilitating attachment of the end member 118 to a part of the device that is to be controlled by the coaxial cable. As is conventional, a terminator 114 may be found at each end of the cable 116.

At the other end of the coaxial cable (opposite the end to which the end member 118 is attached) is a conduit extender, generally indicated as 100. The conduit extender 100 includes two parts, namely a sleeve member 104 and a slider member 106.

The sleeve member 104 has an end portion 305 press fit around one end of the conduit 102. The sleeve member 104 defines a cable channel 402 through which the cable 116 may pass from a first end 304 to a second end 310 of the sleeve member 104. Integral to the sleeve member 104 is an outward facing ratchet toothed rack 112 toward the second end 310 of the sleeve member 104.

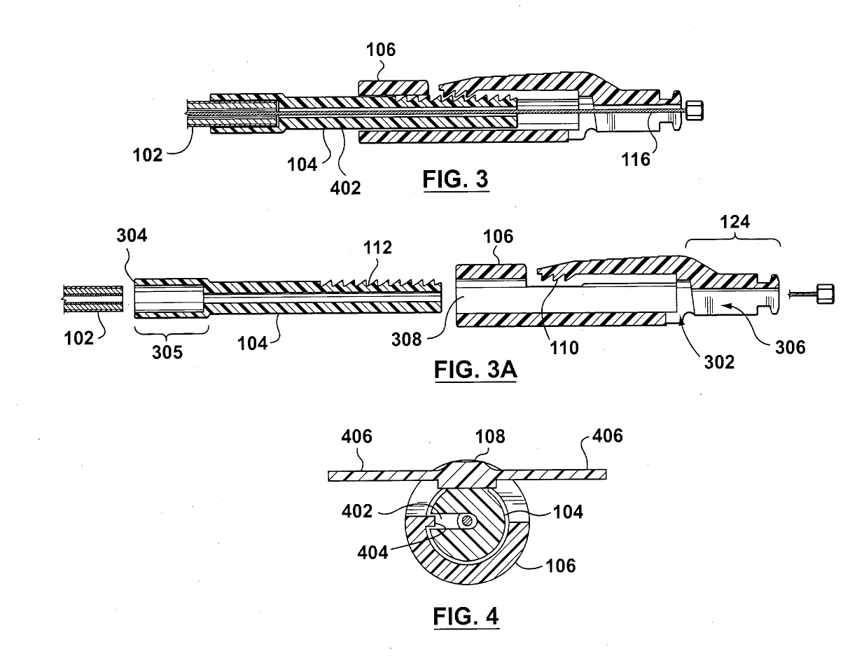

The slider member 106 has a body portion 122 defining a large passageway 308 (see FIG. 3) and a neck portion 124 defining a small passageway 306. The body portion 122 of the slider member 106 also defines a window 202 (see FIG. 2) into the large passageway 308. The slider member 106 includes an integral arm 108 extending from the neck portion 124 of the slider member 106. The slider member 106, including the integral arm 108, may be fabricated of a modestly resilient material such as fiberglass-reinforced nylon, although there are many other suitable materials. The integral arm 108, when relaxed, extends into the window 202. The integral arm 108 has a set of inward facing ratchet teeth 110 sized to engage with the ratchet toothed rack 112 of the sleeve member 104.

For ease of installing the slider member 106 over the sleeve member 104 with a portion of the cable 116 extending therefrom, an opening 302 is provided at a transition between the body 122 and the neck 124 of the slider member 106. The opening 302 allows the terminator 114 at the end of the cable 116 to bypass the small passageway 306. The sectional view of FIG. 5 illustrates, in cross-section, the small passageway 306 in the neck portion 124 of the slider member 106.

A ridge 404 (FIG. 4) extends from the body portion 122 into the large passageway 308 of the slider member 106.

The neck portion 124 has a circumferential groove 126 for facilitating attachment of the slider member 106 to a part of the device that is to be controlled by the coaxial cable.

The free end of the integral arm 108 may be provided with a shape and dimension that permits the integral arm 108 to be manually pulled away from the body portion 122. An exemplary shape is a fluke shape, as illustrated in FIG. 2. A cross-section of the fluke shape of the integral arm 108 is illustrated in FIG. 4, wherein two wings 406 may be identified.

The large passageway 308 of the slider member 106 allows the second end 310 of the sleeve member 104 to be received by the slider member 106. The small passageway 306 of the slider member 106 allows the passage of the cable 116. Once the sleeve member 104 has been received by the large passageway 308 of the slider member 106, the window 202 in the body portion 122 of the slider member 106 allows the ratchet teeth 110 of the integral arm 108 of the slider member 106 to contact the ratchet toothed rack 112 of the sleeve member 104.

In overview, the conduit extender 100 may be used to adjust the effective length of the conduit 102 of a coaxial cable.

In operation, the ratchet teeth 110 of the integral arm 108 the slider member 106 are biased, through the window 202 in the slider member 106, against the ratchet toothed rack 112 of the sleeve member 104 by virtue of the resilient material of which the slider member 106 is constructed. While biased against the ratchet toothed rack 112, the ratchet teeth 110 of the integral arm 108 allow the slider member 106 to be moved in a direction (to the right, as illustrated in FIG. 1) to increase the effective length of the conduit 102. At the same time, movement in a direction (to the left, as illustrated in FIG. 1) to decrease the effective length of the conduit 102, is prevented by engagement between the ratchet teeth 110 of the integral arm 108 and the ratchet toothed rack 112 of the sleeve member 104.

To shorten the conduit extender 100, thereby reducing the effective length of the conduit 102, it is required that the integral arm 108 be lifted (i.e., pulled away from the body portion 122), overcoming the force biasing the ratchet teeth 110 of the integral arm 108 against the ratchet toothed rack 112 of the sleeve member 104, such that the ratchet teeth 110 disengage the ratchet toothed rack 112. The lifting of the integral arm 108 may be performed many ways including manually or through a mechanical linkage. The fluke shape, illustrated in FIG. 2, facilitates a manual lifting of the integral arm 108.

The ridge 404, which extends into the large passageway 308 of the slider member 106, cooperates with the walls of the cable channel 402 of the sleeve member 104 to prevent rotational movement of the slider member 106 about the sleeve member 104. Such rotational movement might, if it were allowed to happen, allow the ratchet teeth 110 to disengage from the ratchet toothed rack 112 unintentionally. Although the ridge 404 suitably prevents rotational movement of the slider member 106 about the sleeve member 104, alternatives are available. For instance, if the sleeve member 104 was of a rectangular cross-section and the large passageway of the slider member 106 was of a parallel shape to receive the rectangular sleeve member, rotation would be avoided.

Advantageously, the conduit extender 100 may be retrofit to existing coaxial cables. The conduit extender 100 may, for instance, replace an existing conduit extender. To install the conduit extender 100, the cable 116 is inserted along the cable channel 402 of the sleeve member 104. The end portion 305 of the sleeve member 104 is then press fit around the end of the conduit 102. The sleeve member 104, with a portion of the cable 116 extending therefrom, may then be inserted into the large passageway 308 of the slider member 106. As the sleeve member 104 is inserted into the large passageway 308, the extending portion of the cable 116 may be directed to pass through the opening 302. The opening 302 is provided in anticipation of the fact that the terminator 114 is too large to pass through the small passageway 306 in the neck portion 124. Consequently, where the terminator 114 is small enough to pass through the small passageway 306 in the neck portion 124, the opening 302 may not be required. The extending portion of the cable 116 may then be inserted along the small passageway 306.

The ratchet teeth 110 and the teeth of the ratchet toothed rack 112 are shown to be right angle triangular. It should be apparent to a person skilled in the art that many tooth shapes exists that serve the same engaging function. Additionally, the teeth of the ratchet toothed rack 112 need not be identical to the ratchet teeth 110. Indeed, while one may define a specific tooth shape, the other may define indentations that receive the specific tooth shape.

Additionally, many different shapes may be available for the integral arm 108. For instance, rather than wings 406 on the sides of the integral arm 108, a loop may be provided on the top of the integral arm 108, where the loop is sized to allow a finger to be inserted to lift the integral arm 108 such that the ratchet teeth 110 disengage the ratchet toothed rack 112.

As will be apparent to a person skilled in the art, the ratchet toothed rack 112 need not necessarily be integral with a sleeve member. Instead, a stand-alone ratchet toothed rack may be attached to the conduit 102. Such an arrangement would require that the large passageway of the slider member be sized to receive the conduit 102 in conjunction with the stand-alone ratchet toothed rack. Operation of such an arrangement, however, would not differ significantly from that described hereinbefore. That is, the ratchet teeth 110 of the integral arm 108 would contact the stand-alone ratchet toothed rack through the window 202 in the slider member 106. It is also contemplated that an especially long integral arm could be arranged to reach beyond the sleeve or conduit receiving end to engage a ratchet toothed rack, thus dispersing with the need for the window 202.

In an alternative embodiment, the slider member 106 is not fabricated entirely of resilient material. Instead, the slider member 106 is primarily fabricated of non-resilient material and resilience is provided only in the fabrication of the integral arm 108 or only at the base of the integral arm 108.

Other modifications will be apparent to those skilled in the art and, therefore, the invention is defined in the claims.

We claim:

1. An extender for a conduit of a coaxial cable comprising:
a first member adapted to be attached to said conduit, said first member having a ratchet toothed rack; and
a slider having an integral arm, said integral arm having ratchet teeth adapted to be biased against said ratchet toothed rack such that said slider may be ratcheted along said ratchet toothed rack to extend an effective length of said conduit.

2. The extender of claim 1 wherein a position of said slider relative to said conduit may be adjusted so as to reduce said effective length of said conduit by raising said integral arm to disengage said ratchet teeth of said integral arm from said ratchet toothed rack.

3. The extender of claim 1 wherein said first member is a sleeve adapted to attach to said conduit and said slider defines a passageway for receiving said sleeve.

4. The extender of claim 3 wherein said slider is adapted to prevent rotational movement of said slider about said sleeve.

5. The extender of claim 4 wherein said slider includes a ridge extending into said passageway and said sleeve has a channel adapted to cooperate with said ridge to prevent said rotational movement of said slider about said sleeve.

6. The extender of claim 1 wherein said integral arm is provided with features to enable manual interaction with said integral arm to displace said integral arm thereby disengaging said ratchet teeth of said integral arm from said ratchet toothed rack.

7. The extender of claim 6 wherein said features include wings extending from sides of said integral arm.

8. The extender of claim 1 wherein said ratchet teeth of said integral arm have a shape adapted to cooperate with teeth of said ratchet toothed rack.

9. The extender of claim 8 wherein said ratchet teeth of said integral arm have a right angle triangular shape and teeth of said ratchet toothed rack have a right angle triangular shape.

10. The extender of claim 1 wherein at least a connection between said integral arm and said slider member is formed of a resilient material.

11. The extender of claim 10 wherein said resilient material is fiberglass-reinforced nylon.

12. The extender of claim 11 wherein said entire slider member is formed of said resilient material.

13. An extender for a conduit of a coaxial cable comprising:
a first member attached to said conduit, said first member having a ratchet toothed rack; and
a slider having an integral arm, said integral arm having ratchet teeth biased against said ratchet toothed rack such that said slider may be ratcheted along said ratchet toothed rack to extend an effective length of said conduit.
